(19) United States
(12) Patent Application Publication
(10) Pub. No.: US 2017/0318995 A1
(43) Pub. Date: Nov. 9, 2017

(54) MAGNETICALLY ACTUATED MIXING AND DRINKING STRAW

(71) Applicant: Raison Investments Inc., New Westminster (CA)

(72) Inventor: Charn Rai, New Westminster (CA)

(21) Appl. No.: 15/527,595

(22) PCT Filed: Nov. 19, 2015
(86) PCT No.: PCT/CA2015/051210

§ 371 Date: May 17, 2017

(30) Foreign Application Priority Data
Nov. 20, 2014 (CA) 2871904

(51) Int. Cl. A47G 21/18; B01F 13/00; A47J 43/27; B01F 13/08; A47J 43/046

(52) U.S. Cl. CPC A47G 21/18; B01F 13/0836; A47J 43/0465; A47J 43/27; B01F 13/0033

(57) ABSTRACT

A magnetically actuated mixing straw for mixing a beverage comprises magnetic protrusions located at boom end of the straw. A beverage container containing the mixing straw is placed on top of a magnetic stirrer that causes the mixing straw to rotate and mix the beverage container contents.

### FIELD OF THE INVENTION

This invention relates to drinking straws for beverages. In particular, this invention relates to a magnetically actuated drinking straw that may be used to mix beverages.

### BACKGROUND OF THE INVENTION

Many beverages are prepared by the addition two or more ingredients into a beverage container or cup. Once the ingredients, which may be liquid or solid, are added into the beverage container, the contents are usually stirred to mix them evenly. Stirring spoons, sticks and rods are commonly used stirring implements.

For beverages that are to be consumed using a drinking straw, in a typical case, the beverage ingredients are combined into a container, a stirring implement is inserted into the container, the implement is stirred, the implement is removed, a lid may be applied, and a drinking straw is placed in the mixed beverage, sometimes through an aperture if a lid is used. The stirring is often done manually by the bartender, barista, or other person preparing the beverage.

A bartender, barista, or person preparing beverages may be required to prepare a series of beverages comprising different ingredients or flavours. In such circumstances, it is desirable to use a clean stirring spoon or rod for each beverage to avoid contamination from the previous beverage. This requires the use of multiple stirring spoons or rods. Alternatively, a single stirring spoon or rod may be rinsed with water between uses.

Drinking straws adapted to be used to also mix beverages are known in the prior art. International Application No. PCT/FR96/01793 to Nard discloses a stirrer that may be combined with a drinking straw. The disclosed stirrer has a clip and an orifice to receive a drinking straw. While the stirrer-straw combination may be used to both stir and drink a beverage, Nard does not disclose an automated method of stirring a beverage.

U.S. Pat. No. 2,613,107 to Hartnett, U.S. Pat. No. 2,979,267 to Miller, and U.S. Patent Publication No. 2008/0128529 to Fernandez disclose other drinking straws adapted with fins, blades, or vanes to mix beverages. The straws are used to manually mix the beverage ingredients prior to their use as a drinking straw.

The manual mixing of a beverage is undesirable since the straw will often be grasped during mixing at a location that a user will place his or her mouth over while drinking a beverage. Additionally, during the manual mixing of a beverage, the person mixing the beverage will typically be unable to begin preparing a second beverage. The inventors have recognized the desirability of providing a means of stirring a beverage using a drinking straw but that does not require manual stirring of the straw.

In the context of laboratories, it is well known to mix liquids using a magnetic stirring bar or wand. Typically, a magnetic stirring bar is placed into a flask containing liquid. The base of the flask is then placed on a magnetic stirrer that generates a rotating magnetic field. The stirring bar couples to the rotating magnetic field causing the bar to spin within the flask and to stir the contents of the flask. U.S. Pat. No. 2,350,534 to Rosinger discloses one example of a magnetic stirrer.

Although a similar magnetic stirring bar might be used to mix beverages, the removal of the bar prior to drinking is advisable. This results in no net saving in manipulation and effort if one wishes to use a drinking straw to consume the beverage.

It is therefore an object of this invention to provide a means of stirring a beverage using a drinking straw but that does not require manual stirring of the straw. Preferably, such means is usable either in the context of manually filled beverage containers or in beverage dispensing machines.

is These and other objects of the invention will be better understood by reference to the detailed description of the preferred embodiment which follows. Note that the objects referred to above are statements of what motivated the invention rather than promises. Not all of the objects are necessarily met by all embodiments of the invention described below or by the invention defined by each of the claims.

### SUMMARY OF THE INVENTION

According to one aspect, the invention comprises a beverage container, for example a glass or cup, a lid with an aperture for retaining a straw, and a drinking straw having at least two protrusions located at or near the bottom of the straw, the protrusions being ferromagnetic so as to be coupleable to a magnetic field and being shaped and located on the straw so as to enable the straw to be rotated about the bottom of the container under the influence of a rotating magnetic field.

In another aspect, the invention comprises a magnetically actuated mixing straw having at least two protrusions at the bottom of the straw, the protrusions being magnetically coupleable to a magnetic field.

In a further aspect, the invention comprises a beverage dispensing apparatus having a receiver for a beverage container. A dispenser within the apparatus dispenses beverage ingredients into the container through an aperture in a lid of the container. A drinking straw is receivable in the container to extend through a separate straw aperture, the drinking straw comprising protrusions at the base of the straw to mix the container contents when the straw is rotated. The protrusions are magnetically coupleable to a magnetic field. A magnetic stirrer is provided in the dispensing apparatus to cause the drinking straw to rotate and mix the beverage ingredients. The container may be removed from the beverage dispensing apparatus after the beverage ingredients are mixed and the straw may be used immediately to consume the mixed beverage.

In another aspect, the invention comprises a beverage container assembly having a beverage container, a drinking straw, and a removable beverage container lid containing an aperture for the drinking straw. The drinking straw comprises a tube with a bottom end and a top end and at least two ferromagnetic protrusions located at the bottom end.

The aperture for the drinking straw may be located substantially in the centre of the removable beverage container lid or may be offset from the centre of the removable beverage container lid. The removable beverage container may also contain an opening, separate from the aperture for the drinking straw, for the introduction of beverage ingredients into the beverage container. The opening may be created by a folding tab or by sliding means on the beverage container lid.

In another aspect, the beverage container assembly further comprises a magnetic stirrer. The magnetic stirrer may be integrated into the base of the beverage container and may be selectively detachable from the base of the beverage container.

In a further aspect, a recess is defined between the ferromagnetic protrusions to located at the bottom end of the drinking straw, the base of the beverage container comprises a stub, and the magnetic stirrer comprises a projection. The recess fits over the stub and the projection fits within the stub. The magnetic stirrer may comprise a rotating magnetic assembly with two magnets extending upwards into the projection.

In another aspect, the invention comprises a drinking straw having a tube with a bottom end and a top end and at least two protrusions located at the bottom end wherein the at least two protrusions are ferromagnetic. The at least two protrusions may be tabs or fins and the drinking straw may further comprise fins, tabs, or vanes located anywhere along the tube between the top end and the bottom end.

In a further aspect, the top end of the tube may be resiliently bendable.

In another aspect, the invention comprises beverage dispensing apparatus having a beverage dispensing tube and a receiver for receiving a removable beverage container. A magnetic stirrer is housed under the receiver in the location where a beverage container is placed.

In another aspect, the invention comprises a method of preparing a beverage. The method comprises the steps of providing a beverage container assembly having a beverage container, a drinking straw comprising a tube with a bottom end and a top end and at least two ferromagnetic protrusions at the bottom end, and a removable beverage container lid containing an aperture of said drinking straw, adding one or more beverage ingredients into the beverage container assembly, disposing the straw though the aperture such that the protrusions lie within the container adjacent to the base of the container, providing a magnetic stirrer under the beverage container, and actuating the magnetic stirrer to cause the drinking straw to rotate with the beverage container.

In a further aspect, the one or more beverage ingredients may be added into the beverage assembly through an opening in the removable beverage container lid. In yet a further aspect, the one or more beverage ingredients are added into the beverage container assembly while the magnetic stirrer rotates the drinking straw.

In another aspect, the invention comprises a beverage container assembly having a beverage container, a first drinking straw, and a guide. The first drinking straw comprises a tube with a bottom end and a top end and at least two ferromagnetic protrusions located at the bottom end. The guide comprises a body comprising a bore for receiving the first drinking straw and an arm extending outwards from the body. The beverage container assembly may have a second drinking straw connectable to the top end of the first drinking straw and may have a removable beverage container lid containing a straw aperture. The arm may be secured to the inner surface of the beverage container.

In a further aspect, the guide further comprises a second arm extending outwards from the body wherein the arm and the second arm extend in opposed directions perpendicularly to the axis of the bore.

In yet a further aspect, the guide further comprises one or more additional arms extending outwards from the body. All arms may extend outwards from the body in a direction that is perpendicular to the axis of the bore.

In another aspect, the invention comprises a stirring implement having a disc-shaped body, at least one magnet contained within the disc-shaped body, an aperture located substantially in the centre of the disc-shaped body, and a guide connected to one side of the disc-shaped body for aligning a drinking straw with the aperture. The guide may be funnel-shaped.

In another aspect, the invention comprises a lid for a beverage container having a first side and a second side, an aperture, and a guide connected to the second side for aligning a drinking straw with the aperture. The guide may be funnel-shaped.

In a further aspect, the invention comprises a beverage container assembly having a beverage container, a drinking straw, and a stirring implement having a disc-shaped body, at least one magnet contained within the disc-shaped body, an aperture located substantially in the centre of the disc-shaped body, and a guide connected to one side of the disc-shaped body for aligning a drinking straw with the aperture.

In a further aspect, the invention comprises a beverage container assembly having a beverage container, a drinking straw, and a lid having a first side and a second side, an aperture, and a guide connected to the second side for aligning a drinking straw with the aperture. The drinking straw comprises a tube with a bottom end, a top end, at least two ferromagnetic protrusions located the at bottom end.

In yet a further aspect, the invention comprises a beverage container assembly having a beverage container, a drinking straw, a stirring implement, and a lid. The stirring implement has a disc-shaped body, at least one magnet contained within the disc-shaped body, an aperture located substantially in the centre of the disc-shaped body, and a guide connected to one side of the disc-shaped body for aligning the drinking straw with the stirring implement's aperture. The lid has a first side and a second side, an aperture, and a guide connected to the second side for aligning the drinking straw with the lid's aperture.

The foregoing was intended as a summary only and of only some of the aspects of the invention. It was not intended to define the limits or requirements of the invention. Other aspects of the invention will be appreciated by reference to the detailed description of the preferred embodiments. Moreover, this summary should be read as though the claims were incorporated herein for completeness.

### BRIEF DESCRIPTION OF THE DRAWINGS

The invention will be described by reference to the detailed description of the preferred embodiment and to the drawings thereof in which:

FIG. 1 is an exploded view showing a beverage container, a lid, a magnetically actuated mixing straw, and a magnetic stirrer according to the preferred embodiment of the invention;

FIG. 2 is a perspective view of a magnetically actuated mixing straw according to a first alternative embodiment of the invention;

FIG. 3 is an exploded view showing a beverage container, a lid, the s magnetically actuated mixing straw of FIG. 2, and magnetic stirrer components according to the first alternative embodiment of the invention.

FIG. 4 is a perspective view of a beverage container, a lid, a magnetically actuated mixing straw, and a magnetic stirrer according to an alternate embodiment of the invention that integrates the stirrer into the beverage container;

FIG. 5 is a perspective view of a beverage container, a lid, a magnetically actuated mixing straw, and a magnetic stirrer according to another embodiment of the invention;

FIG. 6 is front view of beverage dispenser, a beverage container, a lid, and a magnetically actuated mixing straw;

FIG. 7. is a perspective view of a beverage container, a magnetically actuated mixing straw, a magnetic stirrer, and a guide according to a further embodiment of the invention;

FIG. 8. is a perspective view of a lid that may be used with the beverage container shown in FIG. 7;

FIG. 9. is a perspective view of a second straw piece that may be used with the mixing straw shown in FIG. 7 and the lid shown in FIG. 8;

FIG. 10. is a perspective view of the guide shown in FIG. 7;

FIG. 11. is an exploded perspective view of a beverage container, a magnetically actuated mixing straw, a guide, and a lid wherein the top of the mixing straw is above the top of the beverage container;

FIG. 12. is an exploded perspective view of a beverage container, a magnetically actuated mixing straw, a guide, a lid, and a second straw piece wherein the top of the mixing straw is below the top of the beverage container;

FIG. 13. is a front elevational view of a magnetically actuated mixing straw with a ridge;

FIG. 14. is a perspective view of a beverage container with a ridge;

FIG. 15. is a cross-sectional view of a guide in a beverage container;

FIG. 16. is a front elevational view of a guide connected to a magnetically actuated mixing straw;

FIG. 17A is a perspective view of a disc-shaped stirring implement containing a guide for aligning a drinking straw;

FIG. 17B is a cross-sectional view of the disc-shaped stirring implement shown in FIG. 17A taken along line 17B of FIG. 17A;

FIG. 17C is a cross-sectional view of a straw and the disc-shaped stirring implement shown in FIG. 17A taken along line 17B of FIG. 17A;

FIG. 18A is a perspective view of a lid containing a guide for aligning a drinking straw;

FIG. 18B is a cross-sectional view of the lid shown in FIG. 18A taken along line 18B of FIG. 18A;

FIG. 18C is a cross-sectional view of a straw and the lid shown in FIG. 18A taken along line 18B of FIG. 18A; and

FIG. 19 is a perspective view of a beverage container, a straw, the disc-shaped stirring implement shown in FIG. 17A, and the lid shown in FIG. 18A.

### DETAILED DESCRIPTION OF THE PREFERRED EMBODIMENT

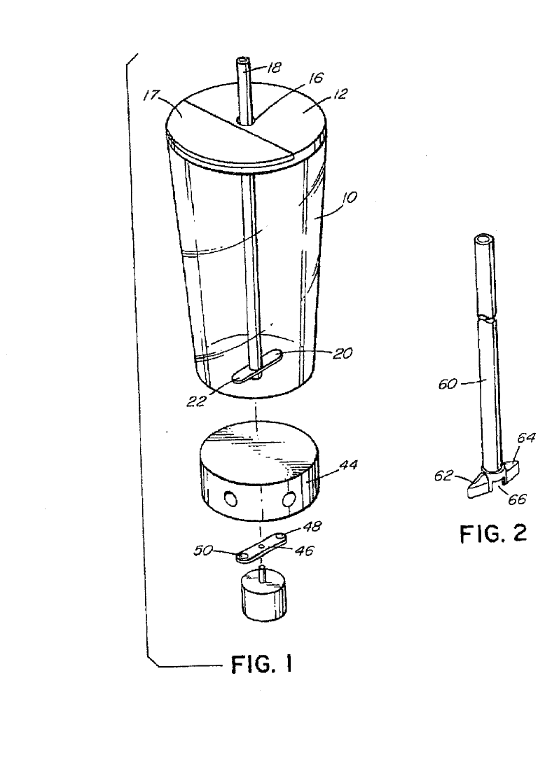

FIG. 1 shows an exploded view of the preferred embodiment of a beverage container 10, a lid 12 having a straw-retaining aperture 16, a magnetically actuated mixing straw 18, and a magnetic stirrer 44 according to the invention.

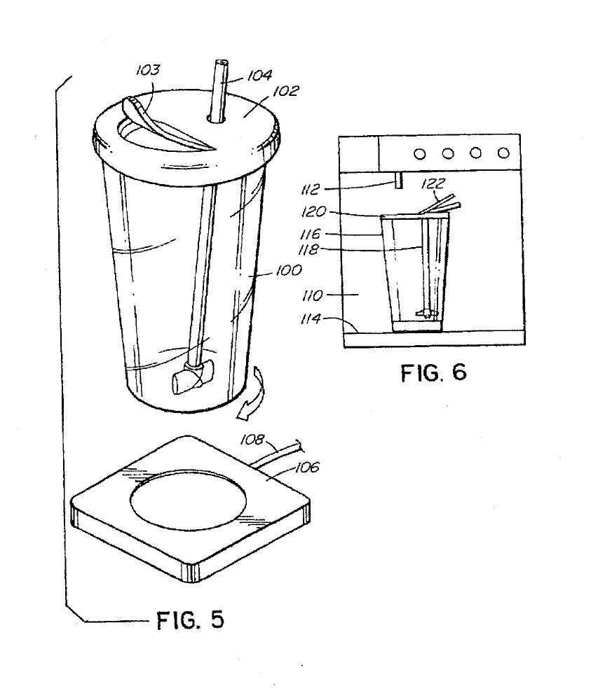

Straw 18 is insertable into the container 10 such that a portion of the straw protrudes through the straw aperture 16. In the preferred embodiment, the straw aperture 16 is located in the centre of the lid, however the aperture may also be offset from the centre such as is shown for example in FIG. 5. The lid 12 also preferably comprises a foldable tab 17 that folds over to selectively create a second opening in the lid 12 to allow beverage ingredients to be added into the beverage container 10 without removing the lid 12.

Straw 18 is a tube with a bottom end and a top end. The bottom end of straw 18 comprises at least two protrusions 20, 22 presenting surfaces for mixing the contents of the container. Preferably, the protrusions extend from opposite sides of the bottom of the straw. The shape of the protrusions may vary and may include, for example, co-planar tabs, angled fins, tabs or fins with or without taper, and with or without apertures, among other possible shapes and arrangements.

As the straw is intended to be rotated by a magnetic stirrer, the shape and location of the protrusions in relation to the base of the straw should be configured to allow the straw to rotate on the bottom of the beverage container. In the event that the lowermost portion of the straw consists of the bottoms of the protrusions themselves, such bottoms are preferably shaped so as to minimize the friction with the bottom of the container. Where the protrusions are spaced from the base of the straw tube, the base will typically provide sufficiently low friction to enable the straw to be rotated about the bottom of the container.

The protrusions 20, 22 comprise a ferromagnetic material capable of coupling to a magnetic field. In the preferred embodiment, protrusions 20, 22 extend about the base of the straw 18 in opposite directions perpendicular to the length of the straw 18. If the protrusions are themselves magnetic so as to have magnetic polarities, the extremities of the two protrusions preferably have opposed magnetic polarities.

Mixing straw 18 may also comprise, in addition to protrusions 20, 22, additional fins, tabs or vanes to assist with the mixing of the beverage as the straw rotates. It will be appreciated that such additional protrusions may be placed anywhere along the length of the straw.

Magnetic stirrer 44 includes a rotating magnetic assembly 46 whose ends 48, 50 have opposed magnetic polarities. As the rotating magnetic assembly 46 spins within the magnetic stirrer 44, it creates a rotating magnetic field above the magnetic stirrer 44 such that when the container 10 is placed over the magnetic stirrer 44, the ferromagnetic protrusions 20, 22 on the base of the mixing straw 18 magnetically couple with the rotating magnetic field and cause the mixing straw 18 to spin and to thereby mix the beverage in the container. Once the beverage is mixed, it may be sipped directly through the mixing straw 18.

It will be appreciated that other straws and magnetic stirrers with greater or fewer protrusions on the straw and different magnetic orientations may be used, provided that the protrusions are capable of magnetically coupling with the rotating magnetic field generated by the magnetic stirrer.

Using the invention, the straw 18 is placed into the beverage container and the lid 12 is placed over the beverage container such that a top portion of straw 18 passes through aperture 16 in the lid 12. One or more beverage ingredients are added into the beverage container 10 through an opening in the lid 12 created by foldable tab 17. The beverage container is placed over the magnetic stirrer 44 and the magnetic stirrer 44 is powered to create a rotating magnetic field that causes the mixing straw 18 to spin or rotate and to thereby mix the beverage.

It will be appreciated that beverage ingredients may be added directly into the beverage container 10 before the lid 12 is placed on top of the beverage container 10. Additionally, the beverage container 10 may be placed on the magnetic stirrer 44 prior to adding the beverage ingredients. The magnetic stirrer 44 may also be powered while the beverage ingredients are being added into the beverage container 10.

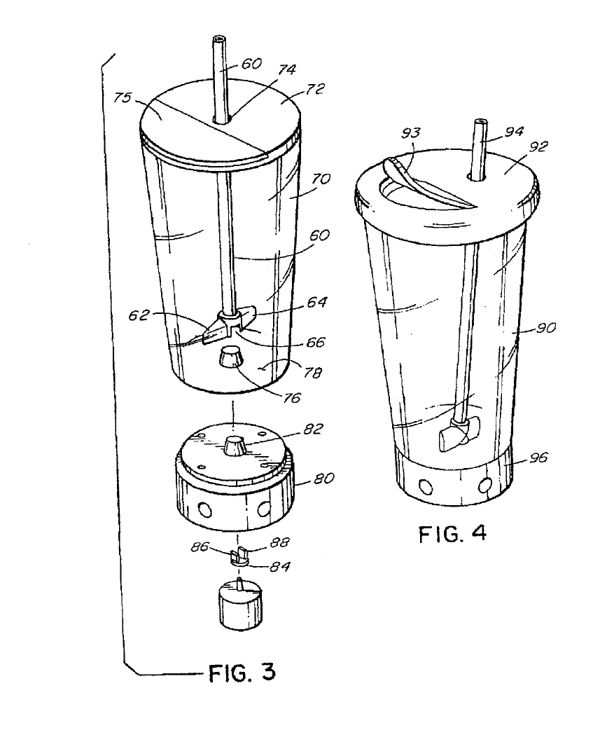

FIG. 2 shows a magnetically actuated mixing straw 60 according to an alternate embodiment of the invention for assisting in keeping the base of the straw centered during mixing. According to this embodiment, a recess 66 is provided between protrusions 62, 64 to fit over a correspondingly shaped stub 76 (FIG. 3) shaped into the bottom 78 of the container 70. This embodiment is preferably used in association with a magnetic stirrer 80 having a projection 82 that fits snugly within the stub 76 on the bottom 78 of the container 70 when the container 70 is placed on top of the magnetic stirrer 80.

The magnetic stirrer 80 comprises a rotating magnetic assembly 84 with two magnets 86, 88 extending upwards into the projection 82 to maximize the proximity of the magnetic field to the protrusions 62, 64. The magnetic assembly 84 spins to create a rotating magnetic field through the projection 82 of the magnetic stirrer 80 and through the stub 76 of the beverage container 70. The rotating magnetic field generated by magnets 86, 88 in the magnetic stirrer 80 couple with the two ferromagnetic protrusions 62, 64 at the base of the mixing straw 60 causing the mixing straw 60 to spin and mix the contents of beverage container 70. Recess 66 and stub 76 allow the base of the straw 60 to remain centered as it spins and enables better magnetic coupling between the ferromagnetic protrusions 62, 64 and the magnetic field generated by the rotating magnets 86, 88 in the magnetic stirrer 80.

A user places the straw 60 into the beverage container and the lid 72 over the beverage container such that a top portion of straw 60 passes through a straw-retaining aperture 74 in the lid 72. In installing the straw 60 into the container 70, the recess 66 between protrusions 62, 64 of the mixing straw 70 is placed over the stub 76 at the bottom 78 of the container 70. One or more beverage ingredients are added into the beverage container 70 through an opening in the lid 72 created by foldable tab 75. The beverage container is positioned over the magnetic stirrer 80 such that the projection 82 fits within the stub 76. The magnetic stirrer 80 is then powered to create a rotating magnetic field that causes the mixing straw 70 to spin or rotate and to thereby mix the beverage.

It will be appreciated that beverage ingredients may be added directly into the beverage container 70 before the lid 72 is placed on top of the beverage container 70. Additionally, the beverage container 70 may be placed on the magnetic stirrer 80 prior to adding the beverage ingredients. The magnetic stirrer 80 may also be powered while the beverage ingredients are being added into the beverage container 70.

FIG. 4 shows an embodiment of the invention in which a magnetic stirrer 96 is integrated into the base of the container 90. The magnetic stirrer 96 may be selectively detachable from the beverage container 90 and may be battery powered to allow a user to move about with a beverage and to easily mix the beverage whenever desired.

In use, the straw 94 is placed into the beverage container and the lid 92 is placed over the beverage container such that a top portion of straw 94 passes through a straw-retaining aperture in the lid 92. One or more beverage ingredients are added into the beverage container 90 through an opening in the lid 92 created by foldable tab 93. The magnetic stirrer 96 integrated into the base of the beverage container 90 is powered to create a rotating magnetic field that causes the mixing straw 94 to spin or rotate and to thereby mix the beverage.

It will be appreciated that beverage ingredients may be added directly into the beverage container 90 before the lid 92 is placed on top of the beverage container 90. The magnetic stirrer 96 may be powered while the beverage ingredients are being added into the beverage container 90.

FIG. 5 shows a beverage container 100, a lid 102 containing a foldable tab 103, a magnetically actuated mixing straw 104, and a magnetic stirrer 106 that may be powered through an electrical outlet by means of power cable 108. It will be appreciated that such a magnetic stirrer may have a flat rectangular or square top surface (as shown in FIG. 5) that is not configured to attach to the base of a beverage container. Instead, the beverage container 100 may be placed directly on top of the magnetic stirrer 106 during mixing. After mixing is complete, the beverage container 100 may then be lifted off the magnetic stirrer 106.

It is contemplated that magnetic stirrers for mixing beverages may be integrated into a beverage dispensing machine. FIG. 6 is a front view of beverage dispenser 110 that has a dispensing tube 112 to dispense liquid or powdered beverage ingredients and a platform 114 that acts as a receiver to support a beverage container 116. Housed under the platform 114 of the beverage dispenser 110 in the location where the beverage container 116 is placed is a magnetic stirrer (not shown) that creates a rotating magnetic field that can couple with a magnetically is actuated mixing straw 118 located within the beverage container 116.

Preferably, a lid 120 has a foldable tab 122 that may be folded over to create an opening in the lid 120 that allows the beverage dispenser to dispense beverage ingredients through the opening and into the beverage container 116 while the lid 120 is on the beverage container 116. It will be appreciated that various alternate means of creating an opening in the lid are possible including sliding means. For example, a lid may have an opening and a sliding panel wherein the panel can slide between a first position that covers the opening and a second position that uncovers the opening.

In some cases, as is shown in FIG. 6, the top of the straw 118 may need to be bent to create an opening in the lid. For such purposes a resiliently bendable top portion of the straw 118 is preferred. In other cases, the means of creating an opening in the lid for the passage of beverage ingredients may not require the bending of straw 118.

To prepare a beverage using the beverage dispenser embodiment of the invention, a beverage container 116 with a lid 120 and magnetically actuated mixing straw 118 is placed on the platform 114 of the beverage dispenser 110. Foldable tab 122 is folded over to create an opening the in lid 120 and one or more beverage ingredients are dispensed into the beverage container 116 through the opening while the beverage container 116 rests on the platform 114. The magnetic stirrer housed under the platform 114 is powered to create a rotating magnetic field that causes the mixing straw 118 to spin or rotate and to thereby mix the beverage. The magnetic stirrer may be powered to mix the beverage while the ingredients are being dispensed or shortly after the beverage ingredients have been dispensed. Once the beverage is mixed, the container 116 can be lifted off the platform 114 and a user can immediately drink the beverage through straw 118.

In the above described embodiments, the straw aperture in the lid restricts the lateral movement of the portion of the mixing straw that passes through it while the straw rotates. Without the straw aperture and lid, the top of the mixing straw would move chaotically about the top of the beverage container as the ferromagnetic protrusions on the base of the mixing straw spin. Such chaotic movement may cause undesirable splashing or spilling of the beverage. The use of the lid with a straw aperture serves to hold the mixing straw in place during mixing.

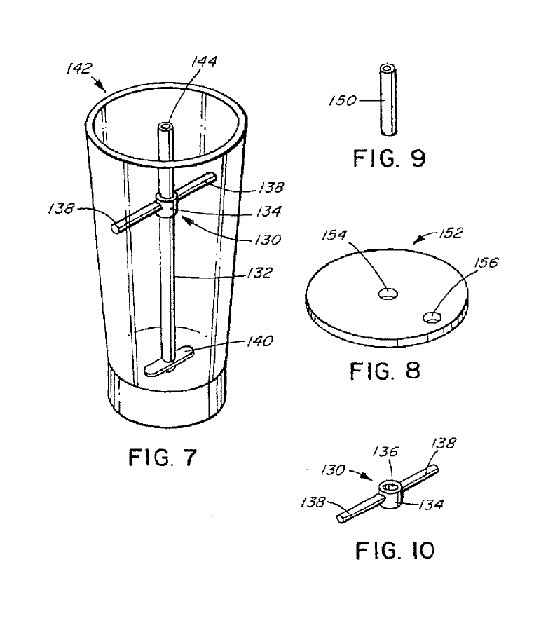

In an alternate embodiment of the invention shown in FIG. 7, a guide 130 (shown also in FIG. 10) is used to prevent the top of a magnetically actuated mixing straw 132 from moving chaotically as a beverage is being mixed. In this embodiment, a lid with a straw aperture is not required to hold the mixing straw 132 in place or to prevent the beverage contents from splashing or spilling out during mixing. The guide 130 keeps the mixing straw 132 vertical. Preferably the guide keeps the mixing straw 132 vertically centered in the beverage container 142.

Referring to FIGS. 7 to 10, in a preferred embodiment the guide 130 has a body 134 containing a bore 136 sized to receive the mixing straw 132. Two arms 138 extend perpendicularly outwards from the body 134 of the guide to near the sides of the beverage container 142. The beverage container 142 is tapered to prevent the guide 130 from falling beyond a certain level. The mixing straw 132 extends up to the top of the beverage container 142. FIGS. 8 and 9 show a lid 152 and second straw piece 150 that may be used with the beverage container 142. The lid 152 contains an aperture 154 for the second straw piece 150. When the lid 152 is placed on beverage container 142 containing the mixing straw 132 and guide 130, the aperture 154 is vertically aligned with the bore 136 of the guide 130 and the top 144 of the mixing straw 132. A second straw piece 150 is inserted into the aperture 154 of the lid 152 to connect the second straw piece 150 with the top 144 of the mixing straw 132.

In operation, the arms 138 of the guide 130 act to maintain the vertical alignment of the mixing straw 132 as the mixing straw 132 rotates. A gap between the bore 136 of the guide 130 and the mixing straw 132 allows the mixing straw 132 to rotate within the guide 130. The guide may remain stationary during mixing or may rotate during mixing due to friction between the rotating mixing straw 132 and the interior bore surface of the guide 130.

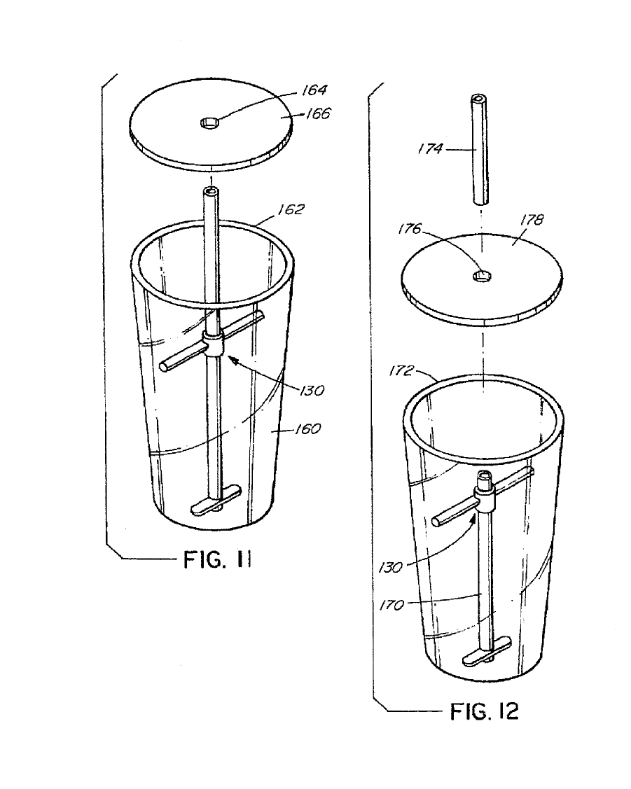

In alternate embodiments, the top of the mixing straw may be above the beverage container (as shown in FIG. 11) or be below the top of the beverage container (as shown in FIG. 12). Referring to FIG. 11, if the mixing straw 160 extends above the top of the beverage container 162, part of the mixing straw will pass through the aperture 164 of a lid 166 placed on the beverage container 162 and a second straw piece may not be required. Referring to FIG. 12, if the top of the mixing straw 170 is below the top of the beverage container 142, the second straw piece 174 will pass through the aperture 176 of the lid 178 when the second straw piece 174 and mixing straw 170 are connected. In this embodiment, the top of the mixing straw 170 is preferably in close proximity to the top of the beverage container 172 so that the second straw piece 174 may be connected to the top of the mixing straw 170 with ease. If there is a large space between the top of the mixing straw 170 and the top of the beverage container 172, it will be difficult to align and connect the second straw piece 174 with the mixing straw 170.

The configuration of the guide 130 may also vary. For example, rather than two arms extending outwards from the body, the guide may contain just one arm. Alternative the guide may have more than two arms. It is also contemplated that the guide's arms may extend outwards from the body of the guide at an angle to the bore rather than perpendicularly to the axis of the bore. If the guide contains just one arm, the end of the arm is preferably secured to the inner surface of the beverage container.

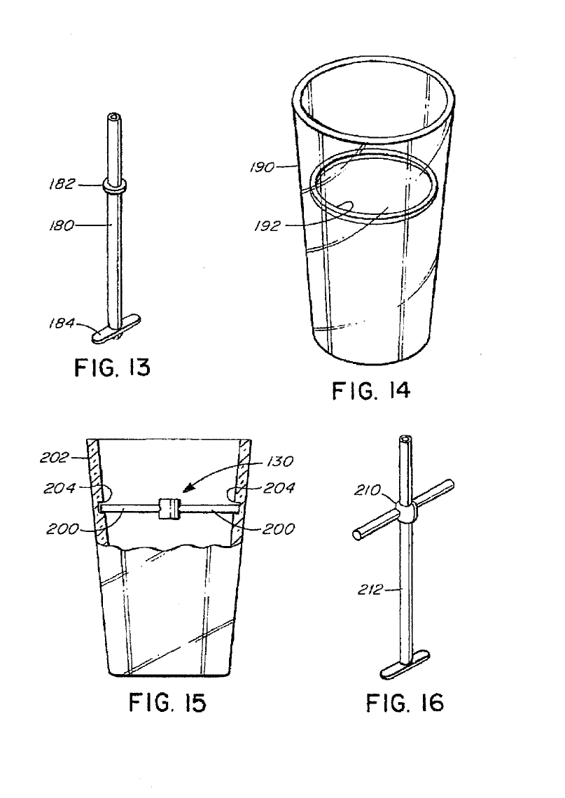

It will be appreciated that there are various other ways to prevent the guide from sliding down the mixing straw and contacting the protrusions. For example and referring to FIG. 13, the outside of the mixing straw 180 may contain a ridge 182 to prevent the guide from sliding down the mixing straw 180 and contacting the protrusions 184. Alternatively and referring to FIG. 14, rather than the mixing straw containing a ridge, the inner surface of the beverage container 190 may contain a perimetral ridge 192 to prevent the arms from falling down. In the further alternative and referring to FIG. 15, the ends of the arms 200 may be engaged to the inner surface of the beverage container 202, for example in a channel 204. In yet a further alternative shown in FIG. 16, the guide 210 may be connected to a portion of the mixing straw 212.

The connection between the guide and the mixing straw may be such that the guide rotates with the mixing straw if the arms are not fixed to the inner surface of the beverage container.

FIG. 8 shows a lid 152 that may be used with the beverage container 142 and mixing straw 132 shown in FIG. 7 and with the second straw piece 150 shown in FIG. 9. The lid 152 may be threaded to fit on the beverage container 142, may be snapped onto the beverage container 142, or may be friction fitted to the beverage container 142.

The lid 152 may contain a straw holder 156 for retaining the second straw piece 150 when it is not in use. The lid 152 may also contain a cap or stopper for the aperture 154 to prevent the contents in the beverage container 142 from coming out through the aperture 154.

The second straw piece 150 and the top portion 144 of the mixing straw 132 may be magnetized to assist with their connection. Alternatively, the second straw piece 150 may be sized to fit snugly inside or outside the top portion 144 of the mixing straw 132.

The magnetic stirrer 160 shown in FIG. 7 may be detachable from the beverage container 142 and may be powered by rechargeable batteries. Such batteries may be charged by induction, by USB cable, or by other charging means known in the art. It will be appreciated that other embodiments of the invention may use such rechargeable batteries, including the embodiments shown in FIGS. 1, 3, and 4.

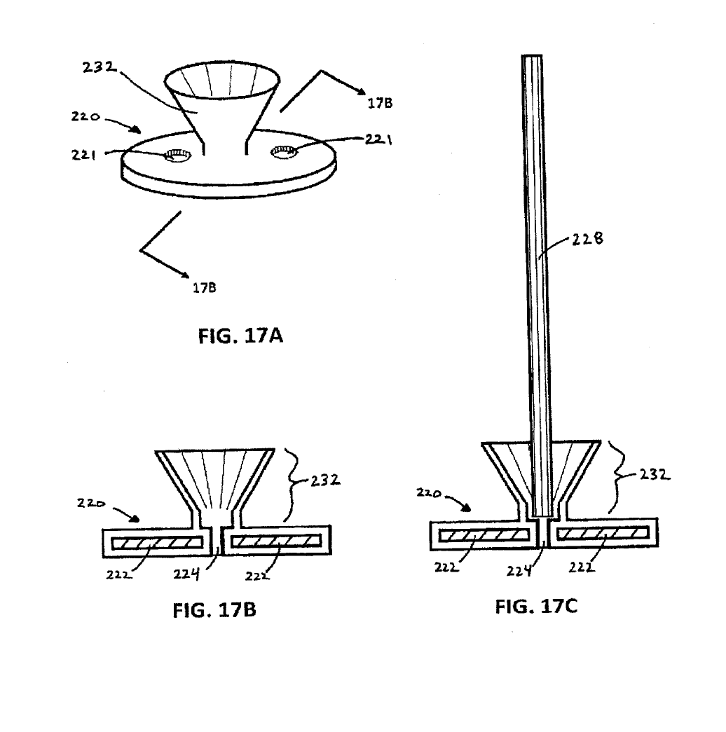

In an alternate embodiment, a drinking straw may be detachable from a magnetic stirring implement. As shown in FIGS. 17A, a magnetic stirring implement 220 may be disc-shaped. Stirring implement 220 contains one or more magnets. For example, the stirring implement 220 may contain two internal magnets 222 as shown in FIG. 17B. The stirring implement may also contain one or more protrusions and/or apertures to assist in mixing. For example, FIG. 17A shows two mixing apertures 221.

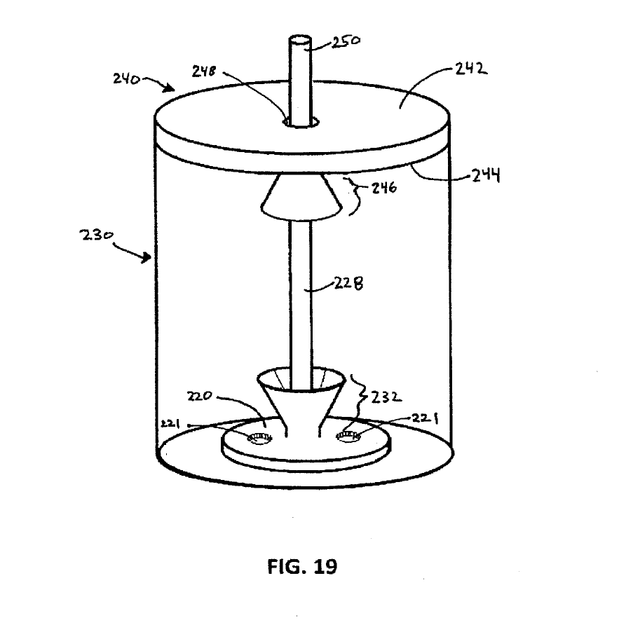

The stirring implement has an drinking aperture 224 located substantially at its centre. The drinking aperture 224 allows liquid to pass through the stirring implement 220 from one side of the stirring implement to the opposite side of the stirring implement. Referring to FIG. 19 for instance, when the stirring implement 220 is placed into a beverage container 230, fluid may be drawn from under the stirring implement 220, through the drinking aperture (shown in FIG. 17C) of the stirring implement, and into the drinking straw 228.

It can be difficult to quickly align a drinking straw 228 with the drinking aperture 224 of the stirring implement 220 when the stirring implement 220 is located at the base of a container 230. A user must carefully try to guide the straw 228 towards the drinking aperture 224. For opaque beverages such as milkshakes or for beverage containers with non-translucent walls, alignment is particularly difficult as a user cannot visually guide the straw 228 to connect with the stirring implement 220 located at the bottom of the container.

To assist in the alignment of the straw 228 with the stirring implement 220, the stirring implement 220 preferably has a guide 232 to direct the drinking straw 228 towards the drinking aperture 224. The guide 232 is located on one side of the stirring implement and is aligned with the drinking aperture 224.

As shown in FIG. 17A, the guide 232 may be funnel-shaped. The funnel-shaped guide 232 is narrowest in circumference at a distance that is closest to the drinking aperture 224 and widest in circumference at a distance that is furthest from the aperture 234.

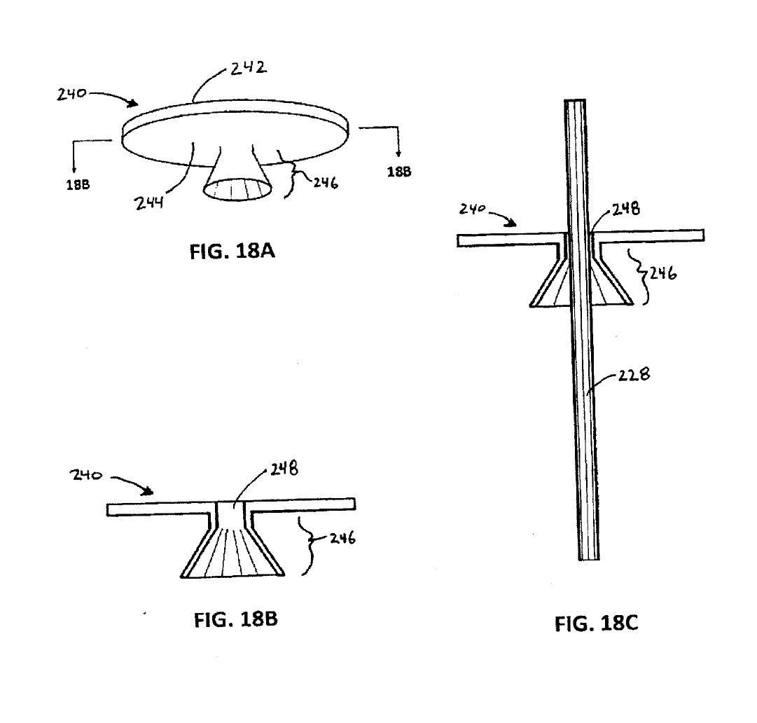

A similar guide may also be located on a beverage container lid to align a straw with an aperture located on the lid. The guide on the lid enables a user to easily place a lid over a straw such that the straw is aligned with an aperture on the lid. FIG. 18A shows a lid 240 with a first side 242 and a second side 244. When placed on a beverage container 230, the second side 244 of the lid 240 faces into the container 230 as shown in FIG. 19. As best seen in FIG. 19, the guide 246 on the lid 240 is substantially aligned with the aperture 248 on the lid 240. The straw 228 may project through the aperture 248 of the lid 240 such that the top portion 250 of the straw lies above the first side 242 of the lid 240.

In one embodiment, the guide 246 on the lid 240 is funnel-shaped and located on the second side 244 of the lid. The funnel-shaped guide is narrowest in circumference at or near the location that it is closest to the aperture 248 of the lid 240 and is widest in circumference at or near the location that is furthest from the aperture 248 of the lid 240.

Referring now to FIG. 19, the stirring implement 220 with the guide 232 may be used in combination with a lid 240 having a guide 246 to keep a straw 228 vertically aligned within a beverage container 230. During operation, a magnetic stirrer (not shown in FIG. 19) under the bottom of the beverage container 230 is powered to cause the stirring implement 220 to rotate and mix the contents of the beverage container 230.

It will be appreciated that the lid 240 with the guide 246 may be used with a standard tubular drinking straw. Alternatively, the lid 240 may be used with any of the straws described above and shown in FIGS. 1-7, 11-13, and 16. For the shorter straw 170 shown in FIG. 12, the guide 246 on the lid 240 would need to be of sufficient length to reach the top of the straw 170. That sufficient length would be approximately the length of the straw subtracted from the height of the beverage container.

The preparation and mixing of a beverage may be controlled by logic stored in the magnetic stirrer used to mix the beverage or logic stored in the beverage dispenser. Such logic may be contained in software stored on a microcontroller is located within the magnetic stirrer or the beverage dispenser. The magnetic stirrer may communicate with a beverage dispenser and use the logic to control the sequence and quantity of beverage ingredients added into a beverage container, the mixing speed of the magnetic stirrer, and the mixing duration of the magnetic stirrer.

In the foregoing specification, the invention has been described with reference to specific embodiments thereof. However, the scope of the invention should not be limited by the preferred embodiments set forth in the examples, but should be given the broadest interpretation consistent with the description as a whole. The specification and drawings are, accordingly, to be regarded in an illustrative rather than a restrictive sense.

1. A beverage container assembly comprising:
a beverage container;
a drinking straw comprising:
a hollow tube with a bottom end and a top end; and
at least two ferromagnetic protrusions at opposed locations about said bottom end.

2. The beverage container assembly of claim 1 further comprising a removable beverage container lid containing an aperture for said drinking straw.

3. (canceled)

4. The beverage container assembly of claim 2 wherein said removable beverage container lid contains an opening, separate from said aperture, for the introduction of beverage ingredients into said beverage container.

5-6. (canceled)

7. The beverage container assembly of claim 1 further comprising a magnetic stirrer.

8. The beverage container assembly of claim 7 wherein said magnetic stirrer is integrated into the base of said beverage container.

9. The beverage container assembly of claim 8 wherein said magnetic stirrer is selectively detachable from said base of said beverage container.

10. The beverage container assembly of claim 7 wherein said magnetic stirrer comprises an upwardly extending projection;
wherein the base of said beverage container comprises and upwardly extending stub, said stub having an underside shaped and sized to fit over said projection of said magnetic stirrer; and
wherein said drinking straw has a space defined between said at least two protrusions, said space being shaped and sized to fit over said stub.

11. The beverage container assembly of claim 10 wherein said magnetic stirrer comprises a rotating magnetic assembly with two magnets extending upwards into said projection.

12. A drinking straw comprising:
a hollow tube with a bottom end and a top end;
at least two protrusions at opposed locations about said bottom end; and
wherein said at least two protrusions are ferromagnetic.

13. The drinking straw of claim 12 wherein said at least two protrusions are tabs or fins.

14. The drinking straw of claim 12 further comprising fins, tabs, or vanes located anywhere along said tube between said bottom end and said top end.

15-16. (canceled)

17. A method of preparing a beverage, said method comprising the steps of:
providing a beverage container assembly comprising:
a beverage container;
a drinking straw comprising:
a hollow tube with a bottom end and a top end;
at least two ferromagnetic protrusions located at said bottom end;
a removable beverage container lid containing an aperture for said drinking straw;
adding one or more beverage ingredients into said beverage container assembly;
disposing said straw through said aperture such that said protrusions lie within said container adjacent to the base of said container;
providing a magnetic stirrer under said beverage container; and
actuating said magnetic stirrer to cause said drinking straw to rotate within said beverage container.

18. The method of claim 17 wherein said one or more beverage ingredients are added into said beverage assembly through an opening in said removable beverage container lid.

19. The method of claim 17 wherein said one or more beverage ingredients are added into said beverage container assembly while said magnetic stirrer rotates said drinking straw.

20. The beverage container assembly of claim 1 further comprising a guide comprising:
a body comprising a bore for receiving said first drinking straw; and
an arm extending outwards from said body.

21. The beverage container assembly of claim 20 wherein the guide further comprises a second arm extending outwards from said body and wherein said arm and said second arm extend in opposed directions perpendicularly to the axis of said bore.

22-24. (canceled)

25. The beverage container assembly of claim 20 further comprising a second drinking straw connectable to said top end of said first drinking straw.

26. (canceled)

27. A stirring implement comprising:
a disc-shaped body having two sides;
at least one magnet contained within said disc-shaped body; and
an aperture located substantially in the centre of said disc-shaped body.

28. The stirring implement of claim 27 further comprising a guide connected to one of said two sides of said disc-shaped body for aligning a drinking straw with said aperture.

29-34. (canceled)
